(19) United States
(12) Patent Application Publication
(10) Pub. No.: US 2008/0022578 A1
(43) Pub. Date: Jan. 31, 2008

(54) FISHING ROD HOLDER BASE

(76) Inventor: William L. Follmar, Seattle, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/459,713

(22) Filed: Jul. 25, 2006

(51) Int. Cl. A01K 97/10

(52) U.S. Cl. 43/21.2

(57) ABSTRACT

A rod holder mount adapted to hold a fishing rod support mechanism, the rod holder mount having a locking mechanism with an engagement feature positioned on the lateral portion where a stem portion of a fishing rod support mechanism can reposition the locking mechanism to an unlocked state and have it snap back to a locked state at a proper vertical orientation and the fishing rod support mechanism can be removed by repositioning the locking mechanism to an unlocked orientation with respect to the base portion.

### BACKGROUND

Fishing rod holder base/support mounts have been utilized in the prior art for holding and securing a fishing rod support mechanism. In general, a fishing rod holder mount is adapted to receive a cylindrical stem from any fishing rod support mechanism that extends downwardly therein.

Various fishing rod holder bases have been utilized in various forms. In one prior art form, the rod support mechanism (the device that holds the fishing rod directly) is manipulated about a vertical axis where certain slots engage receiving extensions in the prior art rod holder mount to securely fasten a fishing rod support therein. Experience with such devices has shown that there have been occasions where a fishing rod support mechanism with the rod secured therein has been unintentionally removed from the rod holder mount and lost to the sea or lake. Therefore, as described herein, there is a more desirable rod holder mount where various features and benefits can be appreciated by a broad interpretation of the claims following a detailed discussion of a few examples of carrying out the invention where the broader scope of the invention is to be interpreted by the broadest terminology as recited by the claims.

### BRIEF DESCRIPTION OF THE DRAWINGS

FIG. 1 shows a side view of a fishing rod holder assembly mounted to the base such as the perimeter portion of a water vessel or an edge of a dock;

FIG. 2 is a view of the base portion with the stem shown therein as a hatched line;

FIG. 3 shows a stem portion of the fishing rod support mechanism positioned above the rod holder mount;

FIG. 4 shows a top view of the rod holder mount;

FIG. 5 shows a bottom view of the rod holder mount;

FIG. 6 shows a partial sectional view of the locking mechanism in a locked orientation;

FIG. 7 shows the locking mechanism in an open orientation where the biasing region is in a high-energy stored state and counteracted by a lateral force in some form;

FIG. 8 shows a top view of one form of a locking mechanism;

FIG. 9 is taken at line 9-9 of FIG. 5 showing the lock extension locking the locking mechanism to the base portion;

FIG. 10 shows the locking mechanism in an unlocked orientation;

FIG. 11 shows the locking mechanism position partially removed from the cavity portion of the base portion;

FIG. 12 shows the locking mechanism being positioned in the cavity portion where the lock extension is temporarily repositioned in a manner to allow the locking mechanism to be inserted into the cavity portion;

FIG. 13 shows a sectional view taken at line 13-13 of FIG. 5 showing the stem locking surface and the upper portion of the surface defining a vertically oriented opening;

FIG. 14 shows the stem and more particularly the lower annular lip repositioning the locking mechanism in a first lateral direction;

FIG. 15 shows the locking mechanism repositioned to an unlocked orientation as the lower annular lip repositions the locking mechanism to this orientation;

FIG. 16 shows the locking mechanism in a locked state where it is snapped in a second lateral direction and the stem is retained therein;

FIG. 17 shows the rotational locking surface of the stem engaged to the stem locking surface of the base portion to rotationally fix the fishing rod support mechanism thereto;

FIG. 18 shows the stem repositioned vertically where rotation about a vertical axis of the fishing rod support mechanism is possible;

FIG. 19 shows the locking mechanism positioned in an unlocked state which in one form is executed by pressing the extension and removal of the fishing rod support mechanism or more specifically the stem therefrom;

FIG. 20 shows one possible variation where the base portion is mounted on the side of an object such as a shipboard dock.

FIG. 21 is a top view of the rod holder mount of the second embodiment.

### DETAILED DESCRIPTION OF THE PREFERRED EMBODIMENTS

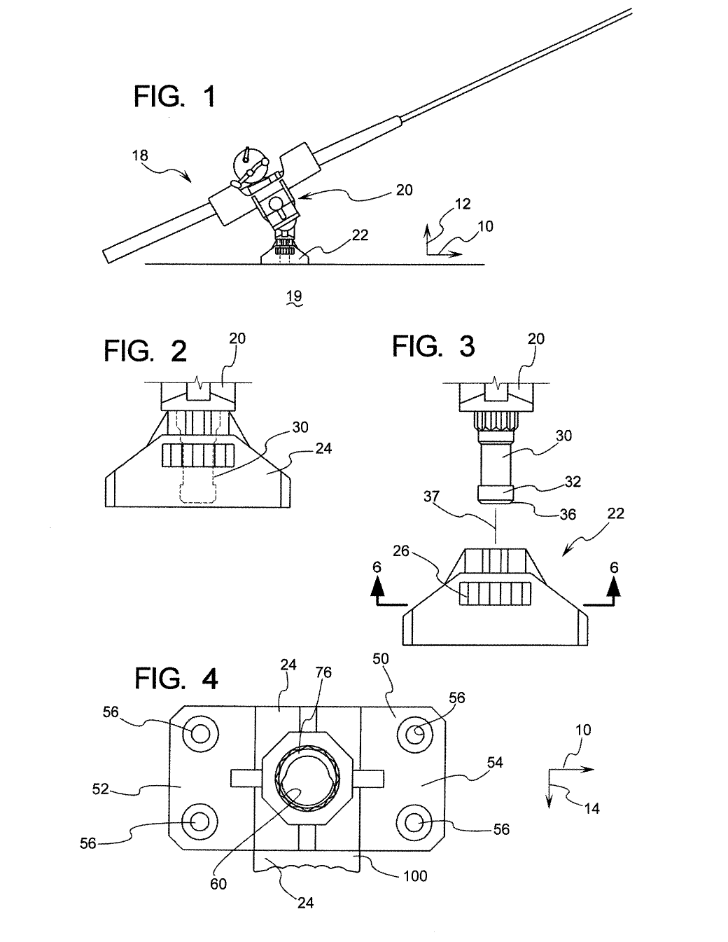

As shown in FIG. 1, there is a fishing rod support mechanism 20 mounted to the rod holder mount 22. In one form, this is a fishing rod support mechanism similar to that shown in Ser. No. 10/989,189, which is hereby incorporated by reference. As shown in FIG. 3, the rod holder mount 22 comprises a base portion 24 and a locking mechanism 26. There will first be a general discussion of the apparatus followed by a more detailed description of the various components thereof. To aid in description of the general components, an axes system is defined where as shown in FIG. 1, the arrow indicated at 10 indicates a longitudinal axis. The arrow indicated at 12 indicates a vertical axis. Now referring to FIG. 4, the substantially orthogonal axis (to that of axes 10 and 12) indicated at 14 indicates a lateral direction pointing in a first lateral direction. Of course the axes described above are not intended to specifically limit the claimed invention but rather are utilized to aid in the description and orientation of the various components.

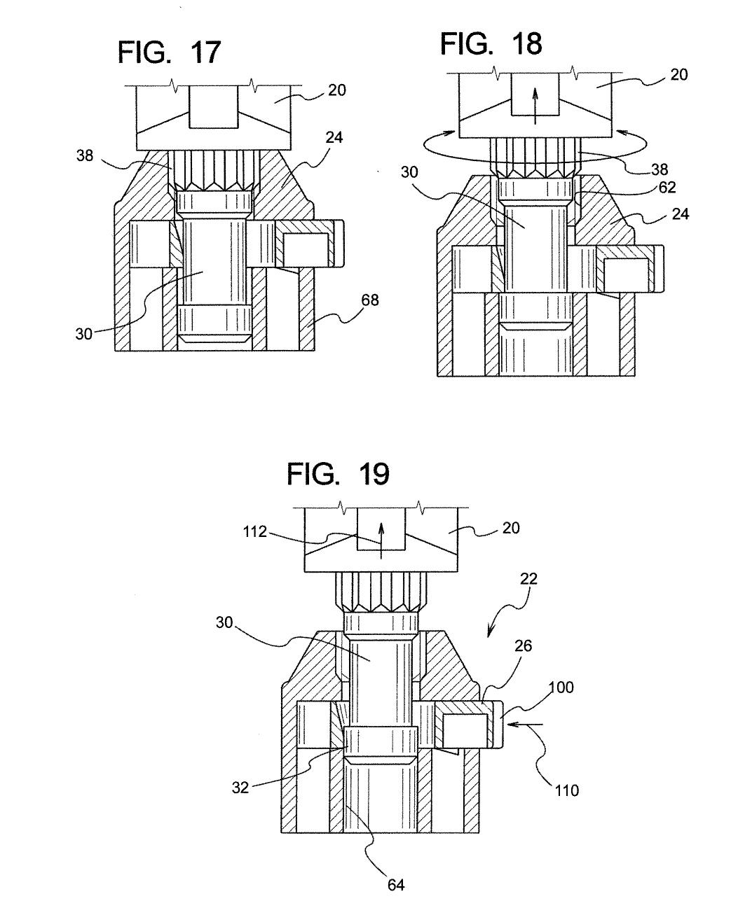

As shown in FIG. 3, it can be seen how the stem 30 is positioned above the rod holder mount 22. In operation, the stem 30 is inserted downwardly within the surface defining a vertically orientated opening 60 (see FIG. 4) to a position as shown by the hatched line in FIG. 2. As shown in FIG. 15, the lower annular lip 32, having in one form a frustoconical surface 36, is adapted to reposition the locking mechanism 26 to an unlocked position. As shown in FIG. 16, as the fishing rod support mechanism is further repositioned downwardly, the lower annular lip is positioned beneath the locking mechanism 26 where it is locked therein. As further shown in this figure, and more specifically in FIG. 18, a rotational locking surface 38 of the stem is positioned vertically above a stem locking surface 62 of the base portion 24. This allows for rotation of the fishing rod support mechanism 20 as indicated by the circular arrow. When it is desirable to rotationally lock the fishing rod support mechanism 20 to the base portion 24, the fishing rod support mechanism is positioned downwardly in a manner as shown in FIG. 17. When the fishing rod support mechanism 20 is desired to be removed from the rod holder mount 22, the locking mechanism 26 is repositioned such that in one form, the protruding release 100 is depressed as indicated by arrow 110 in FIG. 19, so the first portion of the inner surface of the locking mechanism allows free passage of the lower annular lip 32 for removal thereof.

FIG. 3 further shows the lower portion of the fishing rod support mechanism 20 where a stem 30 is shown. Essentially, the stem 30 has a lower annular lip 32 where as shown in FIG. 16, it comprises an upper lock surface 34 and a lower frustoconical surface 36. As shown in FIG. 15, a rotational locking surface 38 is provided which in one form is positioned above an elongated portion 40. In general, the elongated portion 40 has a smaller diameter or cross-sectional area than that of the lower annular lip 32. As described further herein, this allows for rotation of the fishing rod support mechanism 20 while the fishing rod support mechanism 20 is locked to the rod holder mount 22 as described further herein.

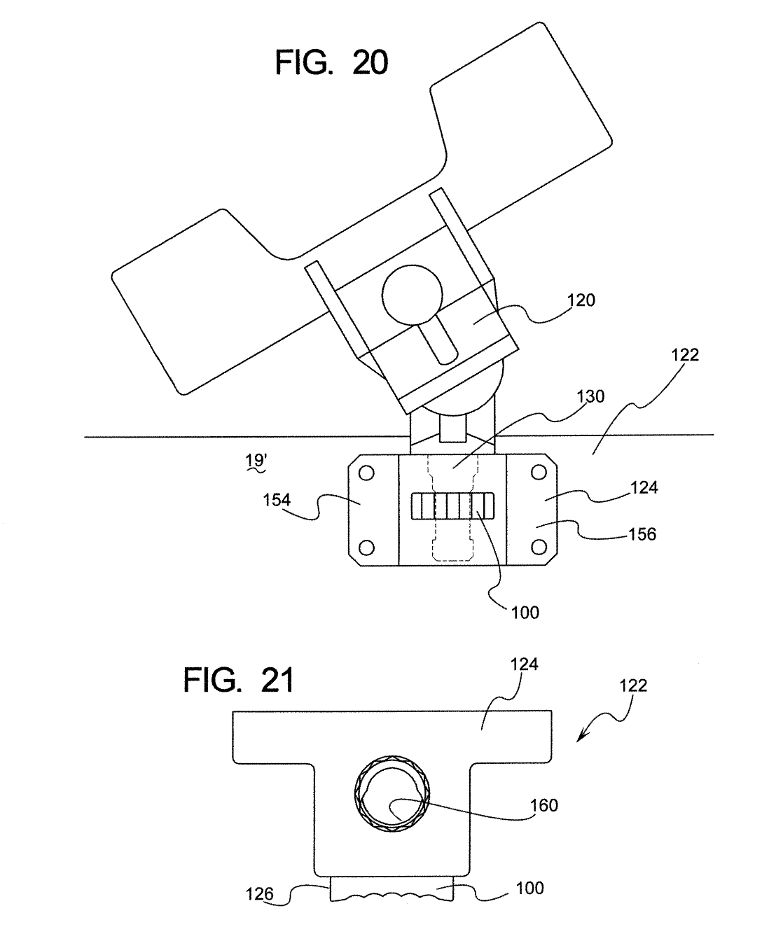

Referring back to FIG. 4, the base mount 24 comprises an attachment region 50 which comprises a first attachment portion at a first longitudinal location 52 and a second attachment (or mounting) portion at a second longitudinal location indicated at 54, surfaces defining the openings 56 are provided to allow such fasteners as screws or nuts and bolts to pass therethrough to fixedly mount the rod holder mount 22 to a base 19 as shown in FIG. 1 as well as shown in FIG. 20 showing another embodiment described further herein.

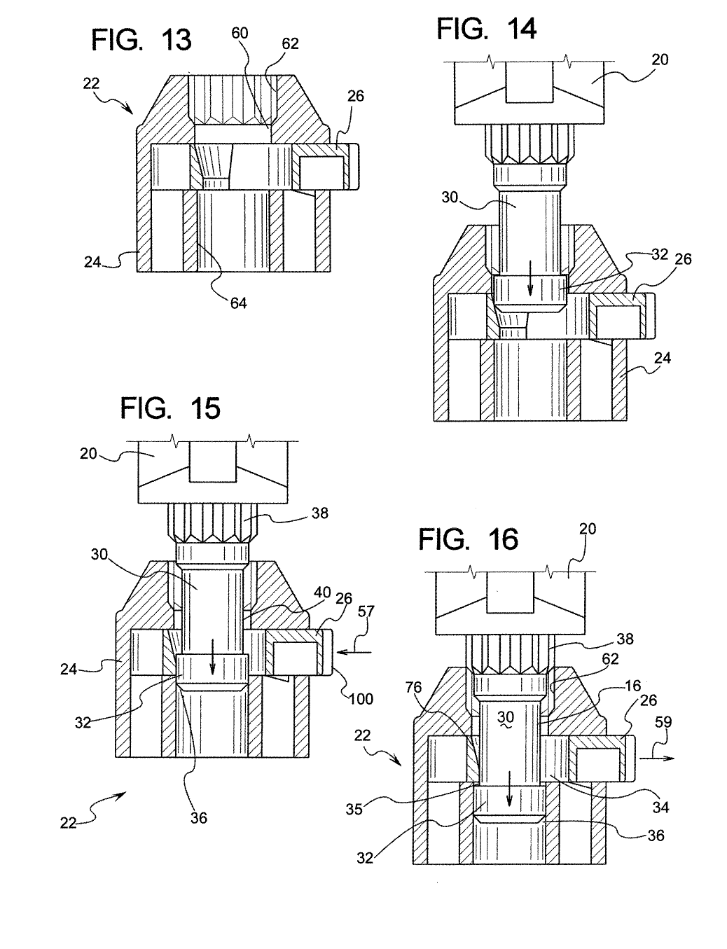

As shown in FIG. 4, there is a surface defining a vertically orientated opening 60. As shown in FIG. 13, the surface 60 as an upper portion 62 which comprises a stem locking surface. The lower portion of 64 is adapted to engage the outer surface of the lower annular lip 32 as shown in FIG. 16-18. Generally, the outer cylindrical surface of the lower annular lip 32 to engage the surface portion 64 so the stem can reposition therein; however, engagement between the lower annular lip and the surface 64 prevents rotation about an axis and the horizontal plane.

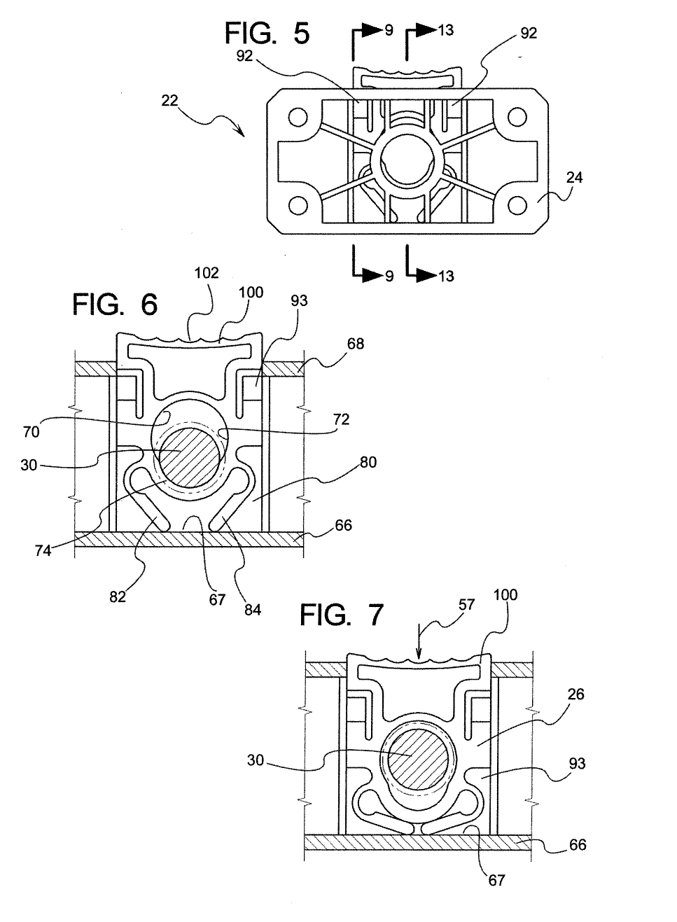

As shown in FIGS. 5-7, the base portion 24 comprises a first lateral wall 66 and a second lateral wall 68. The first lateral wall has an inner surface 67 and as best shown in FIGS. 9-12, the second lateral wall 68 has an inner surface 69 which is adapted to engage a lock extension 90 of the lock mechanism described further herein.

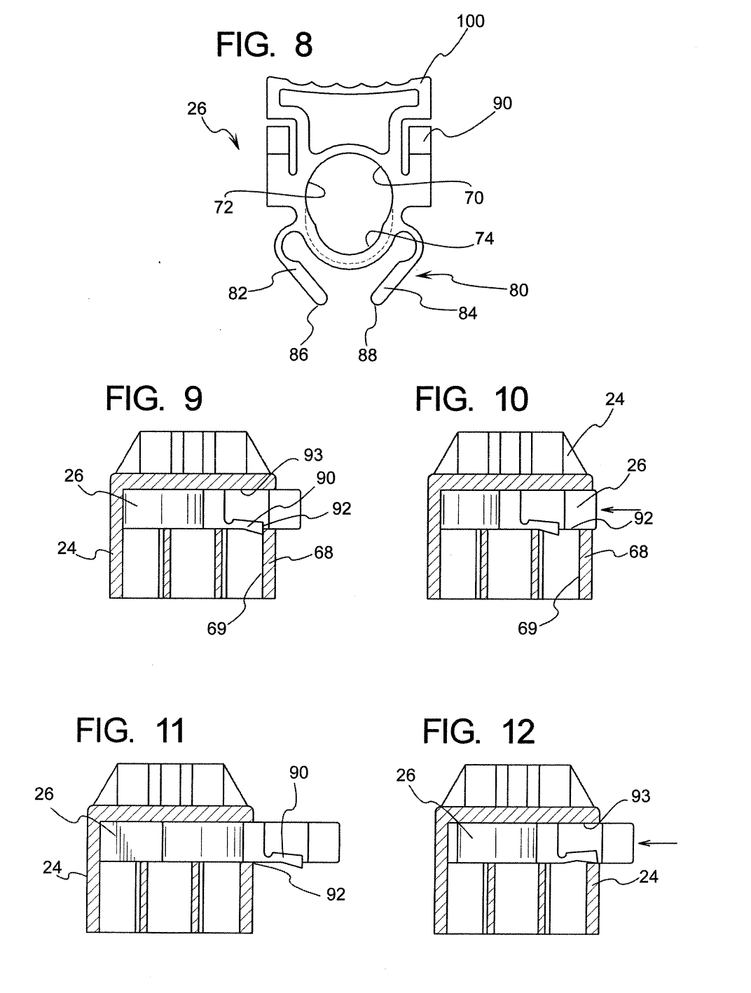

There will now be a discussion of the locking mechanism 26 with initial reference to FIG. 8. In one form, the locking mechanism 26 is a unitary structure comprising an inner surface 70 having a first portion 72 and a second portion 74. The first portion 72 is of a sufficient diameter and cross-sectional opening to allow the lower annular lip to pass therethrough. The second portion 74 has a reduced size diameter and is adapted to engage the elongated portion 40 (see FIG. 16) of the stem 30 and engage the upper lock surface 34 of the lower annular lip to lock the stem to the rod holder mount 22. As shown in FIGS. 13-16, the locking mechanism 26 comprises an angled surface 76 that is adapted to engage the frustoconical surface 36 of the lower annular lip 32 so the locking mechanism is repositioned by a downward action of the stem 30 as described further herein.

Referring back to FIG. 8, the locking mechanism 26 further comprises a biasing region 80. The biasing region 80 comprises, in one form, a leaf XXX spring-like member referred to as a biasing member 82 and further can include a second biasing member 84. In one form, the members 82 and 84 are of a unitary structure with the locking mechanism 26. The members 82 and 84 have surfaces 86 and 88 that in one form are adapted to engage the inner surface 67 of the first lateral wall 66 as shown in FIGS. 6-7. Of course various spring-like elements can be employed, and the biasing region 80 can be that of a unitary structure with the lock mechanism, or a separate structure, or integral with the base portion 24.

Referring back to FIG. 8, in one form, a lock extension 90 is provided where as shown in FIGS. 9-12, the lock extension 90 is adapted to hold the lock mechanism 26 in the base portion 24. As shown in FIG. 11, in one form the lock mechanism 26 is of a unitary structure such as a plastic injected molded part, the lock extension 90 comprising a lock surface 92. As shown in FIG. 12, as the lock mechanism 26 is inserted into the cavity portion 93 of the base portion 24, the lock extension is repositioned as shown in this figure. In a preferred form, the lock extension does not undergo plastic deformation but merely temporarily deforms into this state, and when fully inserted into the cavity region 93, extends to its original position where the lock surface 92 engages the inner surface 69 of the second lateral wall 68. As shown in FIG. 5, the lock extension 92 (where in one form two are provided on either longitudinal portion of the unit) are accessible from the lower view of the rod holder mount 22. Therefore, when the rod holder mount is removed from the base 19 as shown in FIG. 1, the locking mechanism can be removed by merely depressing the lower surface of the lock extension 92 and removing the unit from the cavity 93 (see FIG. 11). As shown in FIG. 10, the lock surface 92 can freely disengage from the surface 69 during the normal operation of the locking mechanism 26. In one form, the surface 92 limits the range of travel in the locked position of the locking mechanism 26 with respect to the base portion 24. Of course, it can be appreciated that the lock extension 90 can function in a variety of forms other than that shown in FIGS. 8-12. For example, the lock extension could be a portion of the base portion such as that located in the upper portion of the cavity 93 which would lock to an inner surface of the locking mechanism 26. Further, the extension could be positioned and engage other services other than the inner surface wall indicated at 69. For example, the lock extension could be positioned on the other lateral portion of the locking mechanism 26.

Referring back to FIG. 8, the locking mechanism further comprises a protrusion or protruding release 100. The protrusion in one form is adapted to extend from the second lateral wall 68 such as that shown in FIG. 6. In one form, the protrusion 100 has a nonplanar surface 102 such as that shown in the various figures which allows for better frictional engagement as well as a tactile feel to the user to know when he is depressing the protrusion. Of course the protrusion could be recessed within the cavity 93 were the fishermen pressures the protrusion inwardly into the cavity 93 of the base portion 24. In this scenario, instead of the open unlocked position as shown in FIG. 7, the protrusion would be, for example, embedded within the surface of the second lateral wall 68.

As shown in FIGS. 20-21, there is another embodiment where the base portion 124 is positioned on a substantially vertical surface base 19′. The first and second longitudinal mounting regions 154 and 156 are positioned in a manner to mount the surface 19′ which can be vertical or perhaps even angled such that, as shown in FIG. 21, the surface defining a vertically oriented opening 160 is substantially similar to the previous embodiments where the vertically oriented opening need not be perfectly vertical as in assembler embodiments but only somewhat vertical to allow the fishing rod support mechanism 120 to be mounted therein. The protrusion 100 is mounted away from the substantially vertical surface 19′ and operates in a similar manner as described above to engage and disengage the stem 130 from the rod holder mount 122.

In operation, as introduced in the initial part of this disclosure, the rod holder mount 22 operates in a manner to allow the fishing rod support mechanism 20 shown in FIG. 1 to be repositioned downwardly into the base portion 24 as shown in FIG. 3 with, in one form, by only using one hand of the fishermen or person handling the rod and the fishing rod support mechanism 20. Essentially, as shown in FIG. 4, the angled surface 76 of the lock mechanism is adapted to engage the lower portion of the lower annular lip 32 (see FIG. 3). In one form, the lower annular lip 32 has the frustoconical surface 36 to assist in repositioning the locking mechanism 26 to an open position. However, any combination of the surfaces 36 and 76 can be employed to impart a lateral force as indicated by arrow 57 in FIG. 7. As shown in FIG. 14, the lower annular lip 32 is shown engaging the locking mechanism 26 and biasing it into an open orientation as the stem 30 repositions downwardly. As shown in FIG. 15, the stem 30 is positioned in a manner where the lower annular lip 32 has biased the locking mechanism 26 to an open orientation. It should be noted that the force indicated at 57 is not necessarily provided by way of the fisherman with his or her other free hand. Rather, with merely downward force of the stem 30, the stem can be locked to the base portion 24. However, the fisherman or other participant can assist in the insertion of the fishing rod support mechanism 20 into the base portion 24 by way of pressing the protrusion 100 laterally inwardly as indicated by arrow 57.

As shown in FIG. 16, the stem 30 continues downwardly and once the lower annular lip 32 passes the locking mechanism 26, the locking mechanism biases laterally outwardly as indicated by arrow 59 and the locking surface 35 on the upper portion of the lower annular lip is now adapted to engage the lower surface of the locking mechanism 26 so the fishing rod support mechanism, or more specifically a stem 30, is locked thereto. It should be noted in the orientation as shown in FIG. 16, the rotational locking surface 38 of the stem is not engaging the stem locking surface XXX so the fishing rod support mechanism 20 can rotate as indicated by arrow XXX in FIG. 18. When a desirable rotational position above the vertical axis 37 (see FIG. 3) is obtained, the stem 30 is positioned downwardly in an orientation as shown in FIG. 17. When the fisherman or individual that is otherwise operating and maintaining the fishing rod holder assembly 18 (see FIG. 1) desires to remove the fishing rod support mechanism 20 or more specifically the stem 30 from the rod or mount 22, he or she merely repositions the locking mechanism 26 as indicated by arrow 110 so the first portion 72 of the inner first surface 70 (see FIG. 6) is in alignment with the lower surface 64 and the lower annular lip can freely pass vertically as indicated by the arrow 112.

XXX To insert somewhere in text above, search introduction of FIG. 4 and put at end of paragraph XXX The extension 100 is shown positioned in a lateral direction as shown in FIG. 4. However, it can be appreciated that it can be orientated in the longitudinal direction (to the left and right) or other oblique directions.

XXX To insert with discussion of FIG. 13. XXX As is further shown in FIG. 13, the stem locking surface 62 is located in the upper portion of the surface defining a vertically oriented opening 60. However, in another form, the surface could be positioned near the lower region 64 where a corresponding tooth-like surface such as that shown as the rotational locking surface 38 of the stem is positioned in the lower portion of the stem 30.

Therefore I claim:

1. A rod holder mount adapted to be positioned on a base to hold a fishing rod support mechanism having a stem, the rod holder mount comprising:
a. a base portion having an attachment region adapted to fixedly attach to the base, the base portion comprising a surface defining a vertically orientated opening,
b. a locking mechanism having an inner surface with a first portion provided with a sufficient cross-sectional open region to provide the stem to freely pass therethrough and a second portion adapted to engage the stem of the fishing rod support mechanism to removably and fixedly attach the stem of the fishing rod support mechanism thereto, the locking mechanism further having a biasing region that is adapted to bias the locking mechanism to a locked orientation where the second portion of the inner surface is in a position to engage the stem of the fishing rod support mechanism and a protruding release extends from the base portion that is adapted to be depressed to reposition the locking mechanism to an unlocked orientation,
c. whereby the stem portion when inserted into the surface defining a vertically orientated opening, the locking mechanism is biased to an unlocked orientation to allow the stem to pass downwardly to an orientation with respect to the base portion so the fishing rod support mechanism is locked thereto.

2. The rod holder as recited in claim 1 where the attachment region provides first and second longitudinal locations to fixedly attach the base portion to the base.

3. The rod holder as recited in claim 1 where the protruding release has a nonplanar surface to aid in frictionally engaging the protruding release when depressed.

4. The rod holder as recited in claim 1 where the locking mechanism and the biasing region are the unitary structure.

5. The rod holder as recited in claim 4 where a leaf-spring like member comprises the biasing region and is adapted to forcefully engage the inner surface of a first lateral wall of the base portion.

6. The rod holder as recited in claim 5 where the protruding release is position adjacent to a second lateral wall opposing the first lateral wall of the base portion.

7. The rod holder as recited in claim 1 where the base portion is adapted to be mounted on an upper vertical surface of the base.

8. The rod holder as recited in claim 1 where the base holder is adapted to be mounted to a substantially vertical surface where the protruding release extends on an opposing region of the base.

9. The rod holder as recited in claim 1 where the release mechanism has a lock extension that is adapted to engage and inner surface of the second lateral wall where the lock extension is repositionable as the locking mechanism is inserted into the base portion and when fully inserted a lock surface retains the locking mechanism therein.

10. The rod holder as recited in claim 1 where the stem further comprises a lower annular lip and a elongated region positioned thereabove with a smaller cross-sectional surface than the lower annular lip and positioned above the elongated region is a rotational locking surface where the rod holder further comprises:
a. the surface defining a vertically orientated opening having an upper region adapted to allow the elongate region of the stem to pass freely therethrough and rotate therein and further lockingly engage the rotational locking surface of the stem to rotationally position the stem therein.

11. The rod holder as recited in claim above where the lower annular lip has a frustoconical surface positioned in the lower portion thereof that is adapted to engage an angled surface of the second portion of the inner surface of the locking mechanism so when the stem is positioned downwardly, the frustoconical surface and the angled surface engage one another to bias the locking mechanism to an open orientation against the biasing region.

12. The rod holder as recited in claim 11 where the base portion is adapted to be mounted on a substantially vertical surface.

13. A method of positioning a rod holder comprising the steps of:
a. retrieving a fishing rod support mechanism having a stem and fixedly positioning a base portion to a base, where the support mechanism has a locking mechanism attached thereto and the base portion has an upper region with a surface defining a vertically orientated opening,
b. positioning the stem in the surface defining a vertically orientated opening and positioning the stem downwardly to bias the locking mechanism to an open orientation where a lower annular lip of the stem engages an angled surface of the locking mechanism,
c. further positioning the stem downwardly where the locking mechanism engages an elongated region of the stem where the stem is locked to a base support which is comprised of the base portion and the locking mechanism,
d. repositioning the fishing rod support mechanism by rotation about a vertical axis,
e. lowering the stem further so a rotational locking surface of the stem engages a stem locking surface of the base portion to rotationally lock the fishing rod support mechanism to the base support.

14. The method as recited in claim 13 where the locking mechanism has a protruding release extending upon a lateral portion of the base portion.

15. The method as recited in claim 14 where a biasing region is a part of the locking mechanism and is positioned on the opposing lateral region of the protruding release within the base portion.

16. The method as recited in claim 15 where the rotational locking surface of the stem is positioned above the elongated region and the stem locking surface is positioned above the locking mechanism.

17. The method as recited in claim 16 whereby the fishing rod support mechanism is repositioned about the vertical axis where the fishing rod support mechanism is lifted in the vertical direction and rotated about the vertical axis and positioned downwardly so the rotational locking surface of the stem engages the stem locking surface to rotationally reposition the fishing rod support mechanism with respect to the base portion.

18. The method as recited in claim 17 where the locking mechanism is adapted to be removed from the base portion whereby a lock extension is repositioned to not engage the base portion and the locking mechanism is removed therefrom.

19. The method as recited in claim 18 whereby the lock extension is accessible to an opening in the lower portion of the base portion.

20. The method as recited in claim 13 where the fishing rod support mechanism is removed by repositioning the locking mechanism so a first portion of an inner surface of the locking mechanism allows the lower annular lip to freely pass therethrough where the locking mechanism is biased against a biasing member from the locked orientation to an unlocked orientation.

21. A fishing rod holder assembly comprising:
a. a fishing rod support mechanism having a rod holder and a stem mount portion,
b. a rod holder mount having a base portion providing a surface defining a vertically orientated opening,
c. a locking mechanism having an inner surface adapted to allow the stem to pass therethrough where the inner surface comprises a lock portion that is adapted to engage an elongated region of the stem where the lock portion does not allow a lower annular lip to pass vertically thereby the surface defining a vertically orientated opening, a biasing member positions the locking mechanism to a locked position with respect to the base portion, a protrusion extending from the base portion is adapted to be pressed to reposition the locking mechanism to an unlocked orientation whereby a first portion of the inner surface of the locking mechanism allows the lower annular lip to pass thereby,
d. whereas the stem mount portion comprises a rotational locking surface that is adapted to engage a stem locking surface of the base portion to rotationally position the fishing rod support mechanism with respect to the base portion.

22. The fishing rod holder assembly as recited in claim 21 where a second biasing member cooperates with said biasing member to maintain the locking mechanism in a locked orientation with respect to the base portion.

23. The fishing rod holder assembly as recited in claim 22 where the biasing member and the second biasing member are a unitary structure with the locking mechanism.

24. A fishing rod holder assembly as recited in claim 23 whereby the protrusion is a unitary component of the locking mechanism.

25. The fishing rod holder assembly as recited in claim 21 where first and second mounting regions are positioned at first and second longitudinal locations to fixedly mount the base portion to a base.

26. The fishing rod holder assembly as recited in claim 25 where the base comprises the perimeter portion of the water vessel.
